(19) United States
(12) Patent Application Publication
(10) Pub. No.: US 2015/0080039 A1
(43) Pub. Date: Mar. 19, 2015

(54) SYSTEMS AND METHODS FOR A MILLIMETER-WAVE-CONNECTED DATA CENTER

(71) Applicant: MaxLinear, Inc., Carlsbad, CA (US)

(72) Inventors: Curtis Ling, Carlsbad, CA (US); Timothy Gallagher, Encinitas, CA (US); Sridhar Ramesh, Carlsbad, CA (US)

(21) Appl. No.: 14/457,953

(22) Filed: Aug. 12, 2014

Related U.S. Application Data
(60) Provisional application No. 61/864,709, filed on Aug. 12, 2013.
(60) Provisional application No. 61/864,683, filed on Aug. 12, 2013.
(60) Provisional application No. 61/864,721, filed on Aug. 12, 2013.
(60) Provisional application No. 61/864,725, filed on Aug. 12, 2013.
(60) Provisional application No. 61/864,729, filed on Aug. 12, 2013.
(60) Provisional application No. 61/864,732, filed on Aug. 12, 2013.

(51) Int. Cl. H04B 7/24; H04W 52/02; H01Q 19/06

(52) U.S. Cl. CPC H04B 7/24; H01Q 19/062; H04W 52/02
USPC 455/500

(57) ABSTRACT

A first server rack configured for housing one or more first servers and for connecting the one or more first servers to a network may comprise a first millimeter wave transceiver circuit at least one phased array antenna, and a lens. The lens and the millimeter wave transceiver circuit may be arranged on the server rack such that millimeter wave signals transmitted by the at least one phased array antenna are focused by the lens to form a first one or more millimeter wave beams at a corresponding one or more determined angles. The first millimeter wave transceiver circuit may be operable to transmit data from the one or more first servers to one or more second servers residing in a second server rack via the first one or more millimeter wave beams.

### PRIORITY CLAIM

This application claims priority to and the benefit of the following application(s), each of which is hereby incorporated herein by reference:

U.S. provisional patent application 61/864,709 titled “Traffic Routing in a Millimeter-Wave-Connected Data Center” and filed on Aug. 12, 2013;

U.S. provisional patent application 61/864,683 titled “Server Rack and Transceiver for Millimeter Wave Connected Data Center” and filed on Aug. 12, 2013;

U.S. provisional patent application 61/864,721 titled “Interference Cancellation in a Millimeter-Wave-Connected Data Center” and filed on Aug. 12, 2013;

U.S. provisional patent application 61/864,725 titled “Antenna Pattern Configuration in a Millimeter-Wave-Connected Data Center” and filed on Aug. 12, 2013;

U.S. provisional patent application 61/864,729 titled “Beam Power Control in a Millimeter-Wave-Connected Data Center” and filed on Aug. 12, 2013; and

U.S. provisional patent application 61/864,732 titled “Auto-Configuration of a Millimeter-Wave-Connected Data Center” and filed on Aug. 12, 2013

### BACKGROUND

Limitations and disadvantages of conventional approaches to interconnecting servers in a data center will become apparent to one of skill in the art, through comparison of such approaches with some aspects of the present method and system set forth in the remainder of this disclosure with reference to the drawings.

### BRIEF SUMMARY

Methods and systems are provided for a millimeter-wave-connected data center, substantially as illustrated by and/or described in connection with at least one of the figures, as set forth more completely in the claims.

### BRIEF DESCRIPTION OF THE DRAWINGS

FIG. 1A shows a side view of a group of server racks interconnected via a millimeter wave spatial crossbar, in accordance with an example implementation of this disclosure.

FIG. 1B shows an example angled surface for reflection of millimeter wave beams in a millimeter-wave-connected data center.

FIG. 2 shows a top (or bottom) view of several groups of server racks each of which comprises one or more spatial crossbars operable to communicate using millimeter wave spatial multiplexing, in accordance with an example implementation of this disclosure.

FIG. 3 shows example interconnections between two groups of server racks.

FIG. 4A shows two example implementations of a millimeter wave spatial crossbar.

FIG. 4B shows an example implementation of circuitry of a millimeter wave spatial crossbar.

FIG. 4C shows a second example implementation of circuitry of a millimeter wave spatial crossbar.

FIG. 5 shows an example server rack comprising a plurality of servers and a spatial crossbar.

FIG. 6 shows an example server rack comprising a millimeter wave beam redundancy

FIG. 7 illustrates example calibration and cancellation operations performed in a spatial crossbar.

FIG. 8 illustrates example closed-loop configuration for a network of spatial crossbars.

FIG. 9 illustrates configuration of a receive antenna pattern of a spatial crossbar.

FIG. 10 illustrates configuration of a transmit antenna pattern of a spatial crossbar.

FIGS. 11A and 11B illustrate example circuitry of a spatial crossbar operable to independently control the transmit strength of each beam.

FIGS. 12A-12C depict beam power control in an example network of three partial spatial crossbars.

FIG. 13A is a flowchart illustrating an example auto-configuration process performed in a spatial crossbar functioning as a network master.

FIG. 13B is a flowchart illustrating an example auto-configuration process performed in a spatial crossbar functioning as a network slave.

FIG. 14 is a flowchart illustrating an example process monitoring and failover in a network of spatial crossbars.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

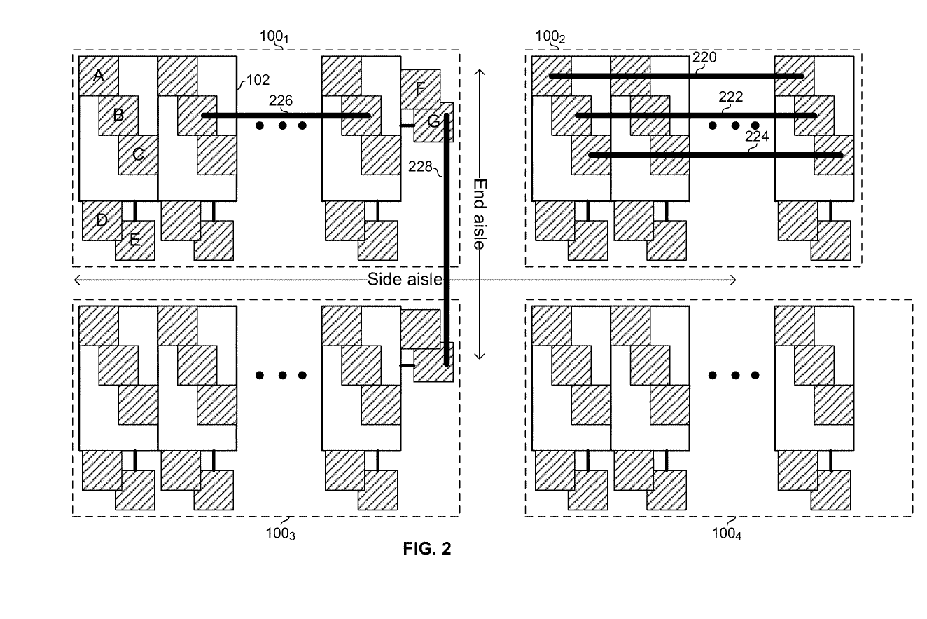

Aspects of this disclosure include using millimeter wave links to connect racks (and/or other components) in a data center. The millimeter wave spectrum enables focused radiation beams, and small antenna dish size. The use of millimeter wave links may provide lossless throughput at lower latency than conventional cable-connected data centers, may consume lower power than conventional cable-connected data centers, eliminate physical/spatial issues present with conventional cable-connected data centers, provide for longer reach than copper cabling (e.g., >˜150 meters), and may enable simplification of core and edge switches. The use of millimeter wave links in the datacenter may enable flattened rack-to-rack communications instead of multiple tiers of switches; may enable 40 Gbps (or higher) full-duplex links, and may enable direct connections among racks rather than via multiple tiers of Ethernet (or other) switches, which may greatly reduce switch latency. The use of millimeter wave links for interconnecting components of data centers may provide for greater scalability than other approaches. One plane of interconnections (e.g., 222 of FIG. 2, below) may occupy, for example, only ˜10 GHz of millimeter wave spectrum, and the narrow beamwidth may enable frequency reuse at close distances (e.g., planes 220 and 224 of FIG. 2 may use the same band of frequencies). Furthermore, the entire 60-150 GHz range may be usable since it is confined inside the data center and not interfering with third-party communications.

Aspects of this disclosure may enable fast, non-blocking traffic between server racks through use of high-speed rack-to-rack dedicated millimeter wave beams and segregation of inter-rack, intra-rack, and core traffic. The use of millimeter wave links may reduce the small form-factor pluggable (SFP) module and cable count in the data center, which may reduce power consumption by 70% or more. The use of millimeter wave links may enable buffering and routing to servers to be done at rack level, and may provide for guaranteed full-rate, lossless connection between server racks. The use of millimeter wave links may enable pushing of routing to the network edge and may also make routing more scalable.

Although various embodiments described herein pertain to spatial crossbars employing millimeter wave technology, other embodiments of the spatial crossbar may use photonics (lasers, phase modulators, optical lenses, and/or the like). For example, rather than bouncing millimeter wave links off a surface that is reflective at millimeter wave frequencies, lasers may be bounced off a surface that is reflective at optical frequencies (i.e. nanometer wavelengths).

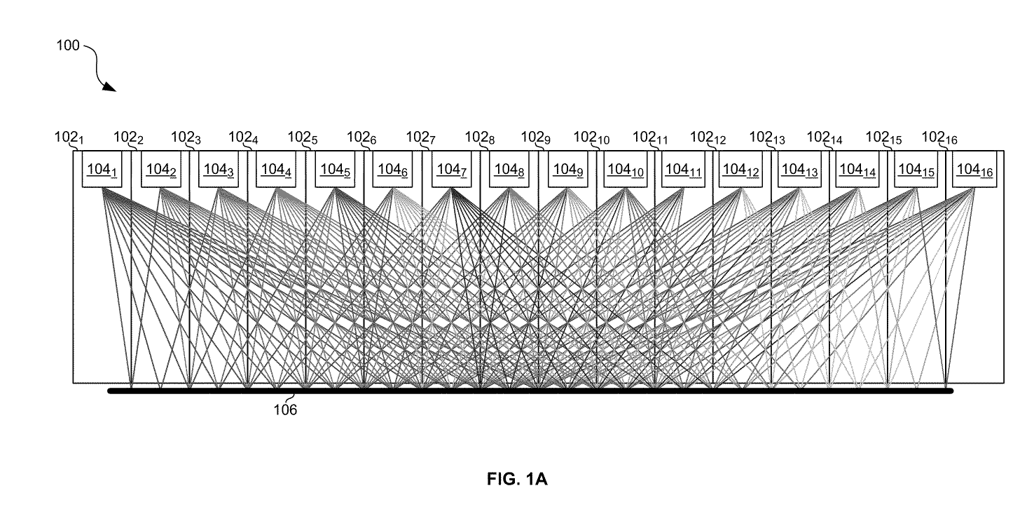

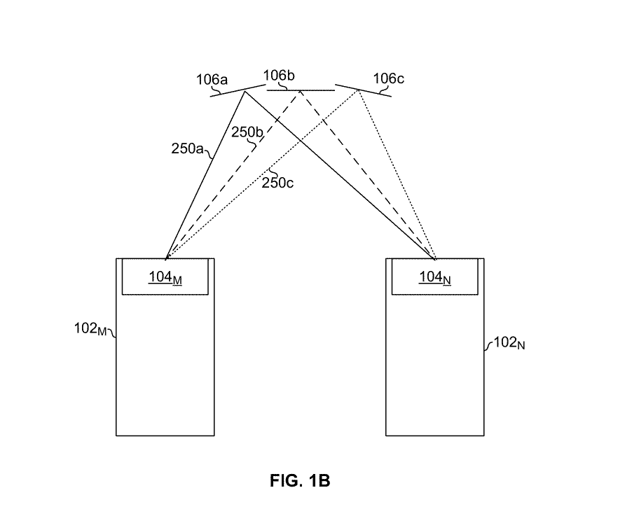

FIG. 1A shows a side view of a group of server racks interconnected via a millimeter wave spatial crossbar, in accordance with an example implementation of this disclosure.

Conventionally, inter-rack communications is via one or more packet switches (e.g., a “tier 1” switch) which introduces substantial latency (e.g., 100s of microseconds). The more pairs or racks that are trying to communicate with each other at any given time, the higher the latency. Conventional switches with N ports require a complexity proportional to N², and also require buffering at the input or output of the switch to accommodate high bandwidth traffic directed at a particular port. Buffering in high speed switches requires memory, queuing, and flow control whose complexity and power consumption increase with switch bandwidth. In addition to these limitations, switch architectures such as hierarchical or Banyan switches need to be routed carefully to avoid blocking.

Shown in FIG. 1A is an example group of server racks 100 in a data center. The example group comprises sixteen server racks 102 each of which may house one or more (e.g., up to forty) servers, and each of which comprises a millimeter wave spatial crossbar 104. Inter-rack communications may be via millimeter wave beams sent between pairs of spatial crossbars 104 that support fifteen (generally speaking, for M racks each spatial crossbar in a fully-connected group of racks may support M−1 concurrent transmit beams at M−1 angles and M−1 concurrent receive beams at M−1 angles) concurrent, full-duplex millimeter wave links. That is, racks 102_{M} and 102_{N} may communicate via millimeter wave beams between spatial crossbars 104_{M} and 104_{N} (for the example shown in FIG. 1, each of M and N is an integer between 1 and 16 and M does not equal N).

The millimeter wave beams may reflect one or more surfaces 106 located in the vicinity around the group 100 (e.g., one or more metallic surfaces located above, below, to one side, and/or to the other side of the group 100). The reflecting surface(s) 106 may be angled and shaped to optimize link formation and efficiency, and/or minimize crosstalk among links. For example, reflectors may be angled to reduce the range of beam steering required of each spatial crossbar 104. A curved surface may be used to refocus each beam to minimize crosstalk. An example of angled surfaces 106 is shown in FIG. 1B. Similarly, absorbing and blocking surfaces may be placed in, on, and/or around the group 100 to minimize crosstalk between millimeter wave beams and control the emission of millimeter waves to other areas of the data center and/or external to the data center. Any two or more millimeter wave beams may intersect and pass through each other without interference, eliminating the need for a switching element or for inter-rack cables.

Each spatial crossbar 104 may be configured physically (e.g., through antenna shape, size, position, number of elements, etc., lens shape, size, position, etc.) and/or electrically (e.g., beamforming coefficients) to support the desired number of racks and the corresponding beam angles to reach those racks. For example, spatial crossbar 104₁, being located at the end of a group 100 arranged as a row, may be configured in a first manner whereas 104₈, being in the middle of the group 100 arranged as a row, may be configured in a second manner. Each millimeter wave spatial crossbar 104 of the group 100 may maintain individual inter-rack links with each other spatial crossbar 104 of the group 100. Each inter-rack link may operate at full rate without needing input or output buffering.

Traffic into a spatial crossbar 104_{M} may be presorted based on the rack 102_{N} to which the traffic is the destined. This presorting may enable efficient implementation of routing functions within the spatial crossbars 104 and allow for faster routing once the payload is delivered to the destination spatial crossbar 104_{N}.

The low latency and high bandwidth of each spatial crossbar 104 also enables efficient multi-hop routing through one or more intermediary spatial crossbar 104. This allows increased bandwidth between racks 102 and may provide for routing from any particular rack in a group of racks to any other particular rack in the group of racks in a single hop and/or in multiple hops. For example, one rack 102_{M} may communicate to a second rack 102_{N} by using the direct link between their respective spatial crossbars 104_{M} and 104_{N}, as well as taking advantage of available link capacity via the spatial crossbar 104_{X} of a third rack 102_{X}. With a small amount of input buffering, link availability of each spatial crossbar 104 at future times may be easily distributed to other spatial crossbars 104 to allow spatial crossbar routing algorithms to optimize throughput. This distribution can be done on a logical side channel provisioned in the spatial crossbars 104 and/or through conventional IP routing. In this manner, each rack in the group may communicate directly with any other rack in the group via a high bandwidth, low latency link over one or more millimeter wave beams, thus avoiding the latency of the conventional approach of interconnecting racks via packet switches. Furthermore, each of the links may support substantially more bandwidth than conventional Ethernet links.

Whereas conventional architectures lead to much redundancy of storage and processing because the latency required for accessing information on another rack is too great, the low latency achieved by interconnecting server racks via millimeter wave spatial crossbars means that more inter-rack communications can occur while still achieving latency targets. This frees up memory and processing power for performing more tasks and thus leads to a more efficient and faster data center overall.

The frequency band(s) used for the millimeter wave communications may be in unlicensed frequency bands but may also (or alternatively) be in licensed bands as a result of the relatively low transmit power needed and the fact that the transmissions are within the closed environment of a data center. The benign conditions of the data center (little or no airborne particulates, no precipitation, temperature controlled, etc.) permit the unrestricted use of contiguous spectrum in the millimeter wave frequency ranges. The relatively short distances and controlled environment reduce both the transmit power and receive sensitivity required to maintain the link budget, allowing higher and/or more absorptive portions of the spectrum to be used by the spatial crossbars 104. Higher portions of the millimeter wave spectrum allow higher gain antennas with smaller physical size, which increases the possible density of spatial crossbars, while also increasing the available bandwidth for transmission. The benign conditions of the data center also allow all circuitry to be integrated in manufacturing processes (e.g. digital CMOS) which are lower cost and often not suitable for high power generation at millimeter wave frequencies. This allows most or all of the circuitry in the spatial crossbar to be integrated in a monolithic implementation (e.g., a single CMOS die). Notwithstanding, the spatial crossbar may also be partitioned into two or more dies of different manufacturing technologies to optimize the system design. Similarly, the controlled environmental conditions may enable use of frequency band(s) that generally suffer too much atmospheric attenuation to be practical in environments which aren't so precisely controlled. In an example implementation, characteristics (e.g., beamforming, timing, synchronization, frequency, etc.) of the millimeter wave links may be autoconfigured based on a priori knowledge of crossbar/rack/datacenter geometry.

FIG. 2 shows a top (or bottom) view of several groups 100 of server racks 102 each of which comprises one or more spatial crossbars 104 operable to communicate using millimeter wave spatial multiplexing, in accordance with an example implementation of this disclosure. In FIG. 2, the hashed boxes depict example mounting positions for lenses or reflectors of the spatial crossbars 104 to enable communications via millimeter wave beams propagating between racks 102 of a particular group 100 and between racks 102 of different groups 100. FIG. 2 illustrates how spatial crossbars can be arranged in three-dimensional space to take advantage of multiple routing planes to provide increased spatial multiplexing (i.e., to provide many direct and/or reflection lines of sight along which the millimeter wave beams may propagate among racks and groups of racks). As can be seen the lenses or reflectors may be positioned within the boundaries of the racks 102 or may extend into the side and/or end aisles between racks 102. For example, lens positions A, B, and C are within the lateral boundaries of the rack, positions D and E extend into a side aisle, and positions F and G extend into an end aisle. Spatial crossbars 104 at different ones of the positions A-G may operate in the same millimeter wave frequency bands, or they may be allocated different millimeter wave frequency bands. Additionally, positions extending into the aisles may include multiple positions having various heights. In this manner, each of the x (left to right on the drawing sheet), y (top to bottom on the drawing sheet), and z (into and out of the drawing sheet) dimensions may be used for staggering lenses or reflectors to provide increased spatial multiplexing (i.e., to provide many direct and/or reflection lines of sight along which the millimeter wave beams may propagate among servers in a rack, servers in different racks, racks in a group, and/or racks in different groups).

In an example implementation, there may be one millimeter wave spatial crossbar 104 per rack 102. In another example implementation, there may be multiple spatial crossbars 104 per rack 102, with each spatial crossbar 104 serving a subset of one or more servers of the rack 102. In an example implementation, redundant spatial crossbars per rack 102 may be used for multiple spatial routing planes for increased capacity. For example, the lines 220, 222, and 224 in FIG. 2 may correspond to five switching planes that operate concurrently. This may be possible as a result of the narrow beamwidth of the millimeter wave beams and/or interference cancellation techniques implemented in the spatial crossbars. The redundant spatial routing planes may be used to implement redundant connectivity and enable failover in the event of a failure. The spatial routing plane 226 illustrates a plane that is aligned with the plane 222 but the two do not interfere with each other because of the tightly controlled radiation patterns (and there may additionally be a blocker, absorber, etc.). The plane 228 illustrates an example plane that traverses the side aisle.

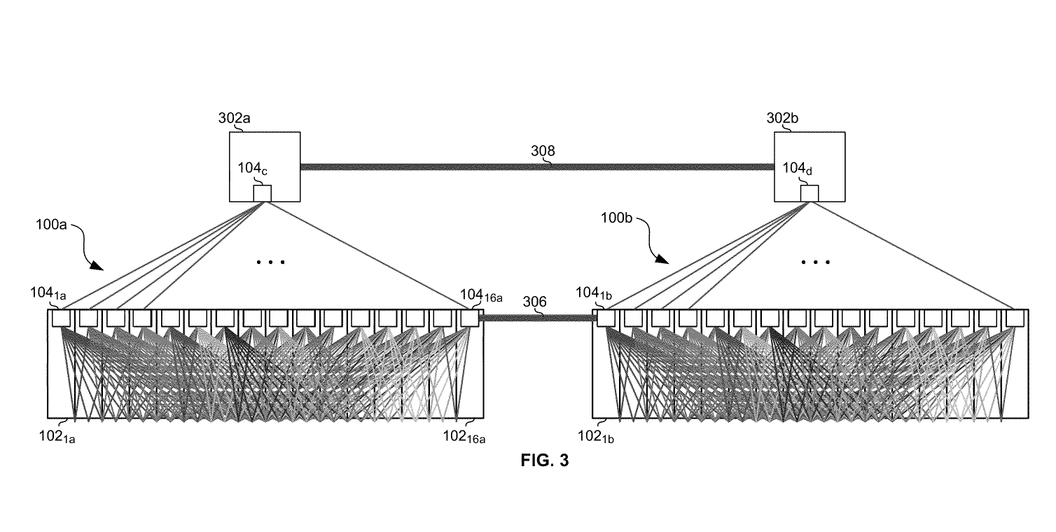

FIG. 3 shows example interconnections between two groups of server racks. FIG. 3 illustrates that inter-group communications between group 100a and 100b may be between rack-mounted spatial crossbars 104 (e.g., between 104₁₆ of group 1 and 104₁ of group 2) and/or via hierarchical switches 302a and 302b.

For inter-group communications via the rack-mounted crossbars 104₁₆ₐ and 104_{1b}, the inter-group link 306 may comprise one or more millimeter wave beams. For inter-group communications via hierarchical switches 302a and 302, the crossbars 104₁ₐ-104₁₆ₐ may establish millimeter wave links with crossbar 104c of switch 302a and the crossbars 104_{1b}-104_{16b} may establish millimeter wave links with spatial crossbar 104d of switch 302a, and then the switches 302a and 302b communicate via link 308 which may comprise one or more millimeter wave beams, optical cables, and/or fiber cables. Inter-group traffic may comprise, for example, traffic between a row of servers and a storage area networking (SAN) rack or traffic between a row of servers and a networking rack.

Because of the low power and narrow beamwidth of the millimeter wave beams, interference between different groups of racks may be minimal and therefore frequency reuse may be employed on a per-group-of-racks basis, for example. Such frequency reuse may be highly beneficial for simplicity of building and scaling the data center. Nevertheless, in some instances certain millimeter wave links may use different frequency bands than other millimeter wave links in order to mitigate interference. Racks, or groups of racks may simultaneously be connected by fiber links and their associated switches such that a hybrid network of millimeter wave and fiber may be constructed.

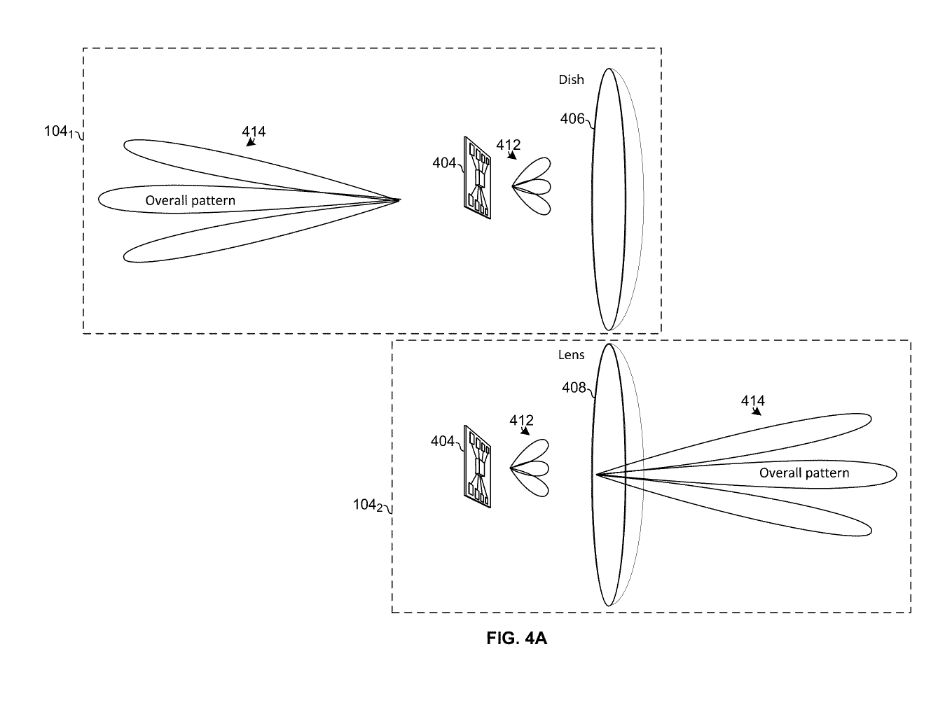

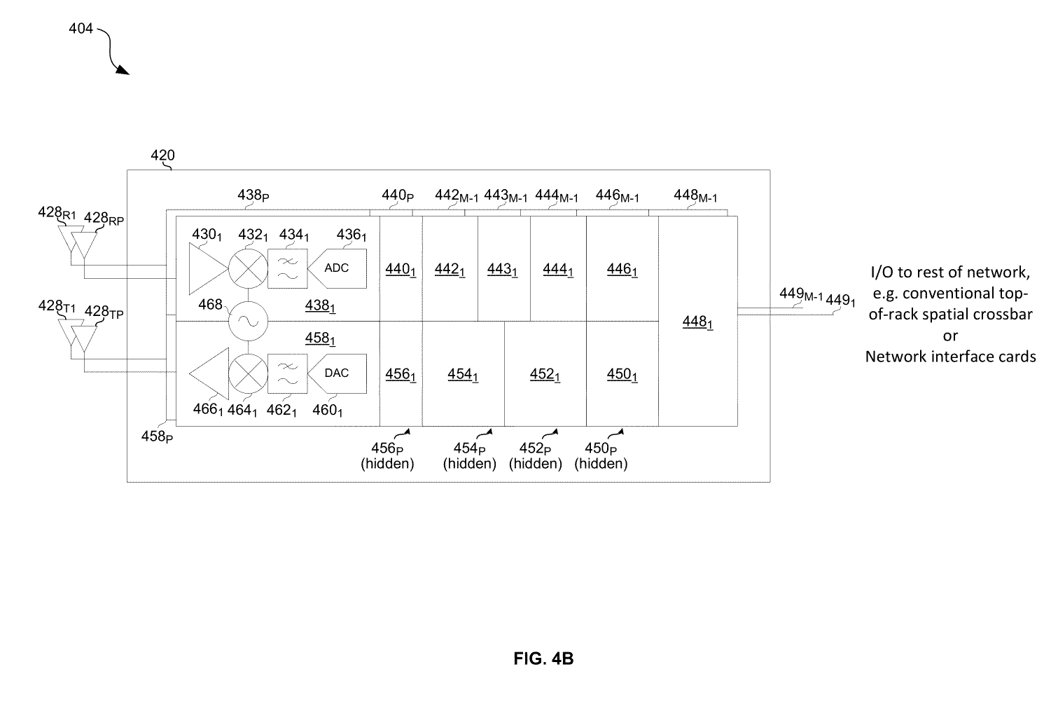

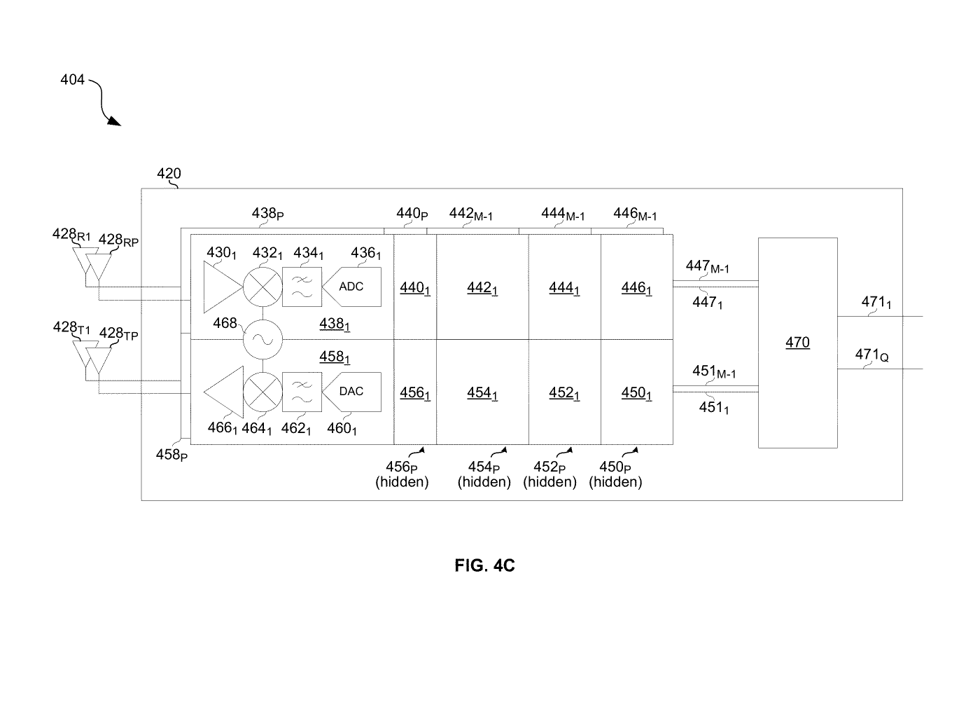

FIG. 4A shows two example implementations of a millimeter wave spatial crossbar. The first implementation 104₁ in FIG. 4A comprises circuitry 404 and a reflector 406. The second implementation 104₂ in FIG. 4A comprises the circuitry 404 and a lens 408. Example implementations of the circuit 404 are described below with reference to FIGS. 4B and 4C.

Whether the implementation 104₁ or 104₂ is chosen for any particular rack 102 may depend on the distances to be covered by the millimeter wave beams, the geometry of the room/racks/servers/etc. in the data center, the layout of the data center, the cost of the lens vs. the reflector, and/or the like. In an example implementation, the size of a racks 102 in which the spatial crossbars 104₁ and 104₂ are housed may be sufficiently large that they can accommodate a lens or reflector diameter of a foot or more. This may enable very narrow millimeter wave beams. Additionally, the distances to be covered by the millimeter wave beams combined with the favorable and highly controlled environmental conditions in the data center may allow the beams to be very low power. Such conditions may make using the lens-type spatial crossbar 104₂ feasible. That is, while the lens 408 is typically more glossy and costly than a comparable reflector 406, here less expensive materials with higher loss may be tolerable due to the low power, environmentally controlled application. The lens may be, for example, cylindrically shaped to support multiple beams in a plane such as the planes 220, 222, 224 in FIG. 2.

For transmit functions, the transmit antenna array of circuitry 404 outputs a radiation pattern 412 which is altered by reflector 406 or lens 408 to result in a millimeter wave beam pattern 414 comprising M−1 highly-focused beams/lobes at desired directions/angles corresponding to the spatial crossbar link partners. Similarly, for receive functions, M−1 millimeter wave beams incident on reflector 406 or lens 408 are redirected and focused on the receive antenna array of circuitry 404.

FIG. 4B shows an example implementation of circuitry of a millimeter wave spatial crossbar. In FIG. 4B, P is a positive integer corresponding to the number of antenna elements used for each of transmit and receive functions by the spatial crossbar and M−1 is a positive integer corresponding to the number of transmit millimeter wave beams and the number of receive millimeter wave beams (e.g., from M−1 other racks in a group of racks). The circuitry comprises a first phased array antenna comprising P (a positive integer) antenna elements 428_{R1}-428_{RP}, a second phased array antenna comprising P antenna elements 428_{T1}-428_{TP}, and a circuit assembly 420. The circuitry 420 comprises P receive analog front-ends 408, P receive filters 440, M−1 receive beamforming circuits 442, calibration and interference cancellation circuits 443, M−1 demodulators 444, M−1 decoders 446, M−1 spatial crossbar input/output circuits 448, M−1 encoders 450, M−1 modulators 452, M−1 transmit beamforming circuits 454, P transmit filters 456, P transmit analog front-ends 458, and a local oscillator 468. Each receive front-end 438 comprises a low noise amplifier 430, a mixer 432, a filter 434, and an analog-to-digital converter 436. Each transmit front-end 458 comprises a digital-to-analog converter 460, a filter 462, a mixer 464, and a power amplifier 466.

For receive functions, the multiple spatially multiplexed beams may be collected via the lens 408 (FIG. 4A) or reflector 406 (FIG. 4A) onto the antenna elements 428_{R1}-428_{RP}. Each element 428_{Rp} (1≦p≦P) may output a millimeter wave signal to a respective receive front-ends 438ₚ. In the receive front-end 438ₚ, the signal is amplified by 430ₚ, downconverted by mixer 432ₚ based on the output of the LO 468, filtered by filter 434ₚ to remove undesired mixing products, and then converted to a digital representation by ADC 436ₚ. The digital signal is then filtered by filter 440p and conveyed to each of the receive beamforming circuits 442₁-442_{M}. Each of the beamforming circuits then performs amplitude weighting, phase shifting, and combining of the P signals to perform spatial demultiplexing to recover a signal corresponding to a respective one of M−1 millimeter wave beams incident on the antenna elements 428_{R1}-428_{RP}. Each beamforming circuit 442ₘ (1≦m≦M−1) then conveys its signal to calibration and interference cancellation circuit 443ₘ which processes the signal to further enhance the signal-to-noise ratio (e.g., I/Q mismatch calibration, near-end crosstalk cancellation, far-end crosstalk cancellation, cross-polarization interference, and/or the like). The output of cancellation circuit 443ₘ is then conveyed to demodulator 444ₘ. Demodulator 444ₘ performs symbol demapping, deinterleaving, and/or other demodulation operations to recover forward error correction (FEC) codewords carried in the corresponding millimeter wave beam, and outputs the data to the decoder 446ₘ. Decoder 446ₘ performs decoding in accordance with a selected forward error correction decoding algorithm to recover data bits from the FEC codewords, and conveys the bits to I/O circuitry 448ₘ. The I/O circuitry 448m then outputs the data on link 449ₘ to other circuitry or components (e.g., to a top-of-rack switch of the rack 102 in which the circuitry 404 resides, to one or more servers 102 in which the circuitry 404 resides, to a hierarchical switch such as 302a (FIG. 3), and/or the like).

For transmit functions, each of M−1 datastreams (e.g., presorted and destined for M−1 racks) may arrive at a respective one of the I/O circuits 448₁-448_{M}. For each datastream, the corresponding I/O circuitry 448ₘ performs whatever processing necessary (e.g., amplification, frequency conversion, filtering, encapsulation, decapsulation, and/or the like) to recover the data from the link 449ₘ and condition the data for conveyance to encoder 450ₘ. Each encoder 450ₘ receives data bits from I/O interface 448ₘ and generates corresponding FEC codewords in accordance with a selected FEC encoding algorithm. Each encoder 450ₘ then conveys the FEC codewords to modulator 452ₘ. The modulator 452ₘ modulates the FEC codeword in accordance with a selected modulation scheme and outputs the modulated signal to each of beamforming circuits 556₁-556_{P}. Each beamforming circuit 556p performs amplitude weighting, phase shifting, and combining of the M−1 signals to generate P signals that, when transmitted via the antenna elements 428_{T1}-428_{TP} will result in M−1 beams, each of the M−1 beams carrying a respective one of the M−1 signals from the modulators 452₁-452_{M} and each of the beams being at an angle determined based on the location of the server rack (or other network component comprising a spatial crossbar) to which it is destined. Each of the P signals from the beamforming circuits 454₁-454_{P} is processed by a respective one of transmit front-ends 458₁-458_{P}. This processing may include digital-to-analog conversion, anti-aliasing filtering via filter 462p, upconversion to millimeter wave frequency band via mixer 464p and LO 468, and amplification via power amplifier 466_{P}. The output of each PA 466p is conveyed to an antenna element 428ₚ which radiates the millimeter wave signal.

In an example implementation the circuit assembly 420 comprises one or more semiconductor die(s) along with one or more discrete components (resistors, capacitors, and/or the like), on a printed circuit board. In an example implementation, the circuitry 420 may be realized entirely using a CMOS process (i.e., no need for GaAs, InP, or other special processes for a power amp or low noise amplifier) due to the low power requirements and high link budget resulting from the short distances and tightly controlled environment of the data center. In an example implementation, the antenna elements 428_{R1}-428_{RP} and 428_{T1}-428_{TP} may comprise microstrip patch antennas integrated on a common PCB with the other components of the circuit assembly 420. The lens may have an anti-reflective coating so as to reduce reflection of transmitted signals back onto the antenna elements 428_{R1}-428_{RP}.

In an example implementation, the circuitry 404 be physically arranged (e.g., on one or more PCBs in one or more housings) so as to provide a desired amount of isolation (e.g., ˜35 to 40 dB) between the transmit antenna array comprising elements 428_{T1}-428_{TP} and the receive antenna array comprising elements 428_{R1}-428_{RP}. For example, the transmit front-ends 438 may be on one side of a silicon (for example) die, the receive front-ends 458 may be on the opposite side of the silicon die, and the baseband circuitry 440-456 may be in the middle of the chip, physically between the transmit front-ends and the receive front-ends. Similarly, the transmit antenna array and receive antenna array may be on opposite sides of a PCB and separated by, for example, ˜4 to 5 inches.

In an example implementation, presorting of traffic may be used to map traffic between the servers and the millimeter wave beams. As an example, there may be M−1 parallel inputs/outputs 449 to M−1 parallel I/O circuits 448, with each input/output corresponding to a particular millimeter wave beam. As another example, packets may arrive in a particular order to a single I/O circuit 448 via a single link 449 (e.g., X (a positive integer) of packets for beam 1, then X packets for beam 2, and so on) and the I/O circuit 448 may direct packets onto and off of the circuitry 420 accordingly.

FIG. 4C shows a second example implementation of circuitry of a millimeter wave spatial crossbar. The implementation of FIG. 4C is similar to the implementation of FIG. 4B, except that the I/O circuits 448₁-448_{M} are replaced by a packet inspection and routing circuitry 470. The packet inspection and routing circuit 470 is operable to route traffic to and/or from Q network ports, where Q is a positive integer. The packet inspection and routing circuit 470 may implement routing protocols that provide for multi-hop routing, which may enable higher transmit burst rates and improved link utilization (e.g., traffic offloaded from a single-hop link comprising a single millimeter wave beam to a two-hop link comprising two millimeter wave beams via an intermediary spatial crossbar). Low PHY latency may reduce the penalty for implementing such routing. Routing table updates may be handled by a side channel (e.g., via a millimeter wave beam and/or a cable). In an example implementation, buffering and flow control may be handled by the packet inspection and routing circuit 470 or may be handled by the circuitry/components on the other end of links 471₁-461_{Q} (e.g., a top-of-rack switch).

An example scenario will help illustrate: Data destined for rack 102₃ may arrive at spatial crossbar 104₁ of rack 102₁ via a fiber or copper link and the packet inspection and routing circuit 470 of spatial crossbar 104₁ of rack 102₁ may direct the traffic onto a millimeter wave beam destined for spatial crossbar 104₂ of rack 102₂. The packet inspection and routing circuit 470 of spatial crossbar 104₂ of rack 102₂ may then determine that the traffic is destined for spatial crossbar 104₃ of rack 102₃ and may direct it to a corresponding millimeter wave beam. In this manner, the spatial crossbar 104₂ of rack 102₂ may receive data via one millimeter wave beam and transmit the data via a second millimeter wave beam, without the spatial crossbar 104₂ having to send the data to a top-of-rack switch or other component of rack 102₂. Upon receiving the data, the packet inspection and routing circuit 470 of spatial crossbar 104₃ may determine that its rack (rack 102₃) is the final destination of the data and may therefore output it via a fiber or copper cable to a top-of-rack switch, server, and/or other component of the rack 102₃.

In an example implementation, a spatial crossbar 104 may multiplex each of M−1 datastreams (each destined for one of the other M−1 racks in a group) among a plurality of the M−1 beams generated by the spatial crossbar 104. By multiplexing multiple datastreams over multiple beams, statistical averaging may be achieved whereby a burst on any particular datastream is likely countered by a lull in one or more of the other datastreams such that the aggregate traffic on any particular one of the multiplexed beams is relatively constant. Where such multiplexing is used, packet inspection and routing circuit 470 may add information (e.g., in the form of a spatial routing header) to enable reassembling packets at the receiving spatial crossbar. One consequence of such a multiplexing scheme is that a portion of any particular datastream will arrive at its final destination in a single hop, while other portions (transmitted on other beams) arrive in multiple hops. Accordingly, the circuitry 420 may comprise buffer memory for packet reassembly. The amount of memory needed may be limited by restricting the total of number of hops to a small number (e.g., 2 or 3 hops). The number of hops tolerated may be traded off with memory and latency requirements. Such multiplexing may provide for extremely high burst rates. For example, assuming a group of racks comprises sixteen racks, each with a spatial crossbar that supports fifteen concurrent, 40 Gbps full-duplex links to each other rack in the group, then the peak throughput available for any particular datastream is 15*40=600 Gbps. Moreover, this peak burst rate can be provided between any two particular racks in a group in a maximum of two hops (in the first hop data sent on one beam reaches the final destination, and in the second hop data sent on fourteen beams reaches the final destination). Such high burst rates may be particularly useful for bursts of data from a server rack to a storage rack or from a server rack to a core networking rack. In an example implementation, such multiplexing of multiple datastreams onto multiple beams may be used in instances where traffic is bursty. Where traffic is relatively stable and/or where aggregate throughput is commonly near the maximum (M−1)*R (M−1 being the number of beams and R being peak data rate per beam), however, datastreams may be dedicated to respective beams in order to prevent head of line blocking or similar problems. In an example implementation using such multiplexing, traffic may be sent such that it always traverses a particular number (e.g., 2) hops. This may simplify packet reassembly by, for example, reducing the amount of buffering needed for packet reassembly.

Routing tables of the packet inspection and routing circuit 470 may be set up dynamically “just in time” based on the traffic to be sent. The trade-off for this flexibility may be some latency as the routing path is configured. Routing metrics (e.g., past, current, and/or predicted utilization of millimeter wave beams) may be communicated (e.g., via an out-of-band channel) among spatial crossbars and used by the packet inspection and routing circuit 470 to configure routing tables. Algorithms used by the packet inspection and routing circuit 470 may be configurable in accordance with a software defining networking standard such as OpenFlow. The packet inspection and routing circuit 470 may prioritize traffic based on a variety of factors such as: the number of millimeter wave hops the traffic has already traversed, the number of millimeter wave hops the traffic yet to traverse, the OFDM subcarriers on which the traffic was received, and/or any other suitable parameter.

In an example implementation, because of the near ideal conditions inside the data center, frequency diversity may not be needed in order to achieve desired performance (e.g., to achieve received error rates below a determined threshold). Accordingly, particular OFDM subcarriers may be assigned to particular traffic and knowledge of this assignment may be used to speed routing (or other processing) of data communicated via spatial crossbars. For example, which OFDM subcarrier data is received on may determine: whether or not the data is destined for the local rack; which spatial crossbar (i.e., which beam) the data is to be forward on; whether or not the traffic needs to be inspected prior to routing, etc.

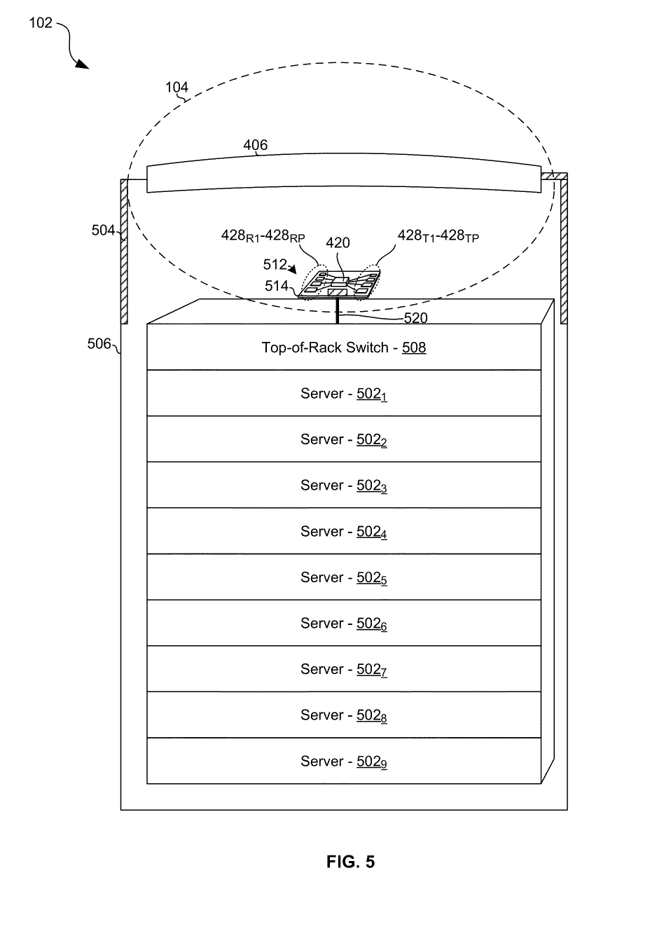

FIG. 5 shows an example server rack comprising a plurality of servers and a spatial crossbar. The example rack 102 of FIG. 5 comprises outer walls 506 and houses nine servers 502, a top-of-rack (TOR) switch 508, and a spatial crossbar 104 comprising circuitry 512 and lens 406. The circuitry 512 comprises PCB 514, circuitry 404, antenna array 428_{R1}-428_{RP}, and antenna array 428_{T1}-428_{TP}. In the example rack shown, the lens 406 is mounted to a top wall of the rack 102 such that the circuitry 404 is enclosed within the rack 102 and millimeter wave beams exit the rack through the lens 406. In other implementations, the lens, or additional lenses, may be mounted to side wall(s) and/or bottom wall(s) of the rack 102. The lens 406 may be made of a plastic or other dielectric material. The lens 406 may be, for example, cylindrically shaped to support multiple beams in a plane such as the planes 220 and 222 in FIG. 2. The lens may have an anti-reflective coating so as to reduce reflection of transmitted signals back onto the antennas 428_{R1}-428_{RP}.

The servers 502 may each connect to the TOR switch 508 via, for example, copper cables or a backplane. The TOR switch 508 may communicate with the spatial crossbar 104 via one or more links 331 which may be copper or fiber, for example.

In an example implementation, surfaces (e.g., inside and/or outside surfaces of the walls 506 and surfaces of the circuitry 404 other than the antenna elements) may be coated with millimeter-wave-absorbent materials 504 (indicated by hashed lines in FIG. 5) so as to reduce reflections. Similarly, surfaces of the rack, circuitry 512, and/or other components of the data system may be shaped so as to reduce the impact of reflections within the rack 102 and external to the rack 102 within the data center.

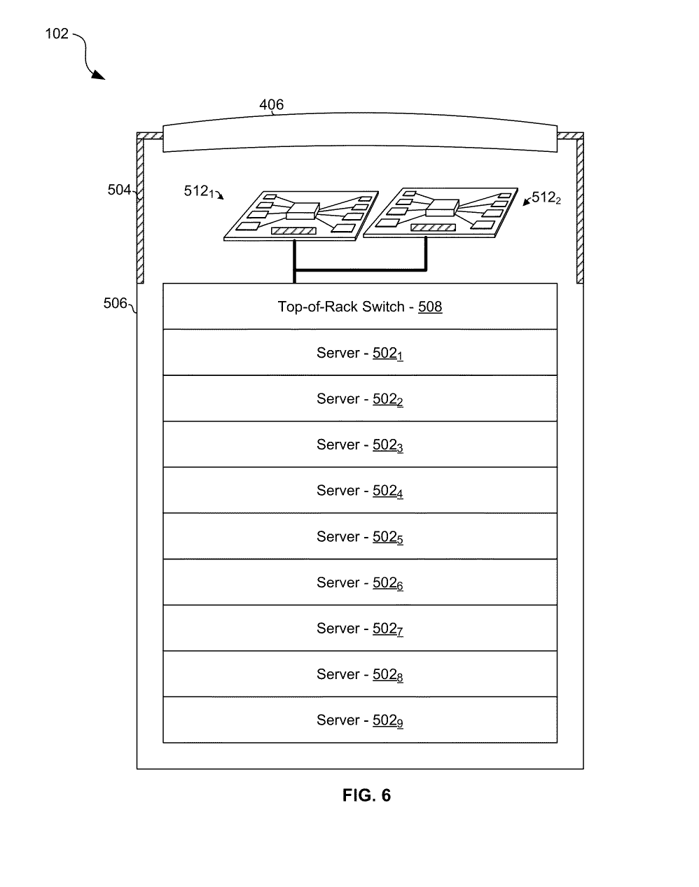

FIG. 6 shows an example server rack comprising a millimeter wave beam redundancy. The spatial crossbar 102 of FIG. 6 is similar to the one shown in FIG. 5, but additionally comprises a second instance of circuitry 512. In an example implementation, the circuitry 512₂ may provide for failover such that, in the event circuitry 512₁ fails, inter-rack communications are not disrupted, or disrupted only momentarily, until an automatic failover occurs and the circuitry 512₂ takes over. While the circuitry 512₁ is operating normally and handling communications, the circuitry 512₂ may maintain state information (e.g., beamforming parameters, cancellation parameters, routing tables, etc.). Such state information may enable a rapid failover, rather than having to go through a whole configuration routine after 512₁ has failed. The state information may be obtained by receiving and processing the beams (but without outputting the resulting data the TOR 508, for example) and/or by receiving the state information via a control channel.

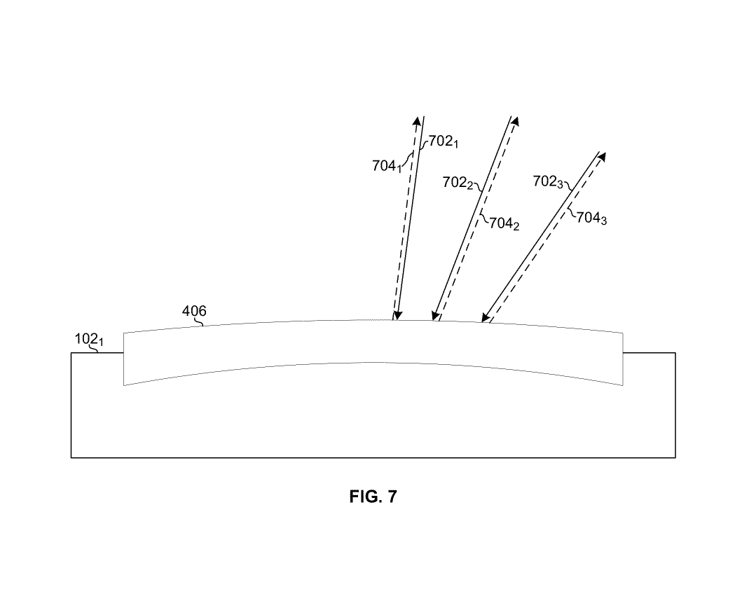

FIG. 7 illustrates example calibration and cancellation operations performed in a spatial crossbar. Shown is a lens 406 of a spatial crossbar 104₁ in rack 102₁. In FIG. 7, the spatial crossbar 104₁ is transmitting beams 704₁, 704₂, and 704₃, and receiving beams 702₁, 702₂, and 702₃. The beams 702₁ and 704₁ may carry data between spatial crossbar 102₁ and spatial crossbar 102₂, the beams 702₂ and 704₂ between spatial crossbar 102₁ and spatial crossbar 102₃, and the beams 702₃ and 704₃ between spatial crossbar 102₁ and 102₄ (for simplicity of illustration, it is assumed in FIG. 7 that M is equal to 4). The calibration and cancellation circuitry of the circuitry 512 of the spatial crossbar 102₁ may be operable to cancel interference among the various beams. For each received signal 702ₘ (for m from 1 to M−1) the received signal may be equal to, or approximately equal to

502ₘ+Σₖ₌₁^{M-1}(αₖ·504ₖ). EQ. 1

Accordingly, cancellation performed in the circuitry 512 may comprise zeroing out the alpha parameter. The cancellation may take advantage of the fact that the spatial crossbar 102₁ has knowledge of the content of its own transmissions.

Pilot patterns may be used to aid in the interference cancellation. In an example implementation, a different pilot pattern may be transmitted on each beam by each spatial crossbar. Correlation with the known pilot patterns may then be used to detect portions of a received beams attributable to interference with other beams.

Where orthogonal frequency division multiplexing (OFDM) is used, interference may be determined and cancelled on an OFDM sub-band by OFDM sub-band basis. That is, alpha in EQ. 1 above may be frequency dependent (there may be M−1*N alphas, where N is the number of OFDM subcarriers).

Parameters for cancellation/calibration may be configured during an initial bring-up/auto configuration of the spatial crossbars 102₁, 102₂, 102₃, and 102₄ at which time only the pilot tones may be transmitted. Additionally, or alternatively, the pilot tones may be periodically transmitted at determined times (and, for OFDM, on determined OFDM sub-bands) and those pilot tones may be used to configure or update the cancellation/calibration parameters. Slowly calibrating over many OFDM symbols carrying the pilot patterns may average out effects of noise and between beams. Slowly calibrating may be suitable because the parameters themselves may change very slowly due of the largely static environment of the data center.

Where different polarizations are used, the circuitry 443 (FIGS. 4A and 4B) may be operable to perform cancellation of cross-polarization interference. For an OFDM system, a separate FFT may be performed on each of the polarizations and then sub-band by sub-band cancellation may be performed.

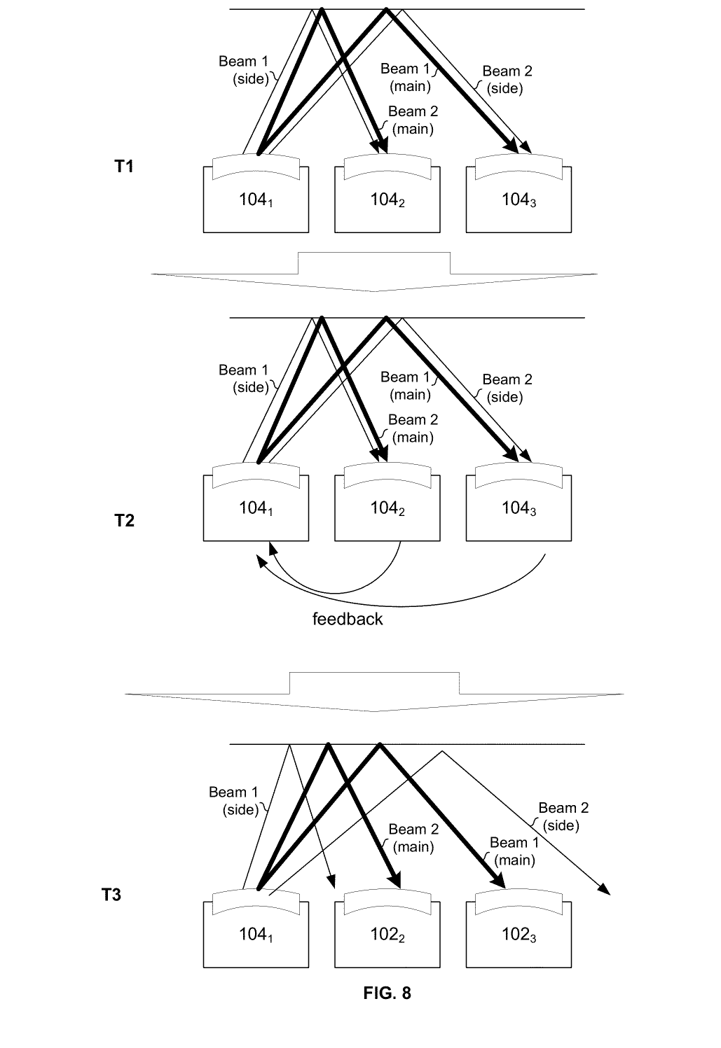

FIG. 8 illustrates example closed-loop configuration for a network of spatial crossbars. Shown are three spatial crossbars 102₁-102₃ interconnected via their respective millimeter wave beams.

At time T1, the main lobes of beam 1 and beam 2 are properly aligned such that 104₁ can transmit to 104₂ and 104₃. Problematic for 104₂, however, is that a side lobe of beam 1 is directly hitting it with sufficient power that SNR of beam 2 may be degraded below a tolerable level. Similarly, problematic for 104₃ is that a side lobe of beam 2 is directly hitting it, potentially causing problems in the reception of beam 1. The spatial crossbars 104₂ and 104₃ may detect these side lobes and determine their source. Determining the source may comprise, for example, correlation with unique pilot tones transmitted on each of beams 1 and 2 and then a lookup in memory of which beam of which spatial crossbar is associated with the detected pilot tones.

At time T2, the spatial crossbars 104₂ and 104₃ may send a report (e.g., via a control channel) to spatial crossbar 104₁ alerting the spatial crossbar 104₁ that the two side lobes are causing problems.

At time T3, the spatial crossbar 104₁ may reconfigure its transmit antenna pattern (e.g., by adjusting amplitude and/or phase coefficients used by its beamforming circuitry 442) such that the power of the side lobes incident on spatial crossbar 104₂ and 104₃ drops below a tolerable level.

Although only transmit beams of spatial crossbar 104₁ are shown for clarity of illustration, similar calibration of antenna patterns may be performed by the spatial crossbars 104₂ and 104₃. Similarly, although only transmit pattern calibration is shown in FIG. 8, each of the spatial crossbars 104₁-104₃ may similarly perform receive pattern adjustment. In this regard, receive pattern adjustment and transmit pattern adjustment may be used in combination in each of the spatial crossbars 104₁-104₃ to increase the degrees of freedom available to arrive at a combination of antenna patterns having suitable SNR for all links.

Instead of, or in addition to, the closed loop configuration of the antenna patterns described above, open loop configuration of the antenna patterns may also be used. Open loop configuration may take advantage of the well-defined, well-controlled, largely-static environment of the data center. Specifically, the location of each spatial crossbar may be known and fixed. Therefore, a theoretically best configuration of each antenna pattern may be determined using numerical analysis or some other optimization routine.

In an example implementation, open loop configuration may be used as a base line at power up of the data center and then closed loop may be used to refine the configurations to account for non-idealities, etc.

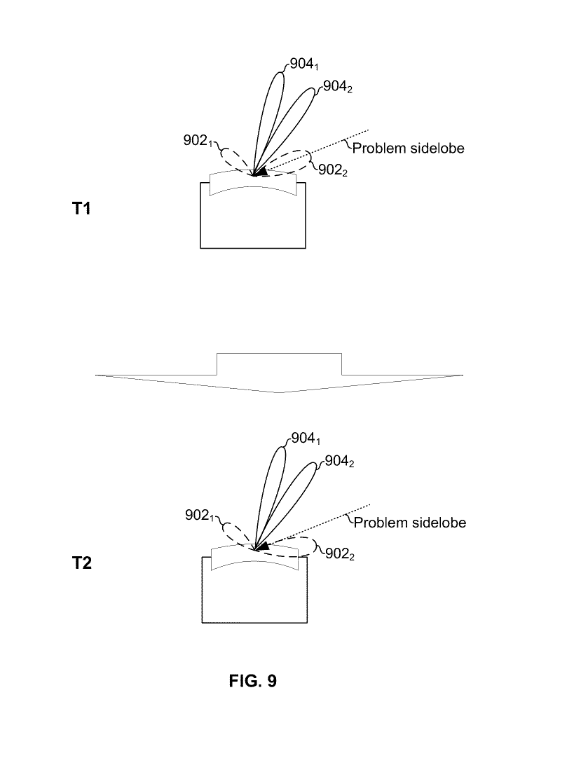

FIG. 9 illustrates configuration of a receive antenna pattern of a spatial crossbar. At time T1 the spatial crossbar 104₁ detects that a problematic transmit side lobe 1002₂ is incident at an angle corresponding to a receive side lobe of the spatial crossbar 104₁. In response, at time T2, the spatial crossbar 104₁ may adjust its receive antenna pattern to place a null at the angle corresponding to the angle of incidence of side lobe 1002₂. The null may be placed by adjusting parameters (e.g., amplitude and/or phase coefficients) used by beamforming circuitry 442 of the spatial crossbar 104₁. The number of nulls that the spatial crossbar 104₁ may be able to place, and therefore the number of problem transmit side lobes that may be addressed in such a manner, may be determined by the number of receive antenna elements 428_{R1}-428_{RP} of spatial crossbar 104₁.

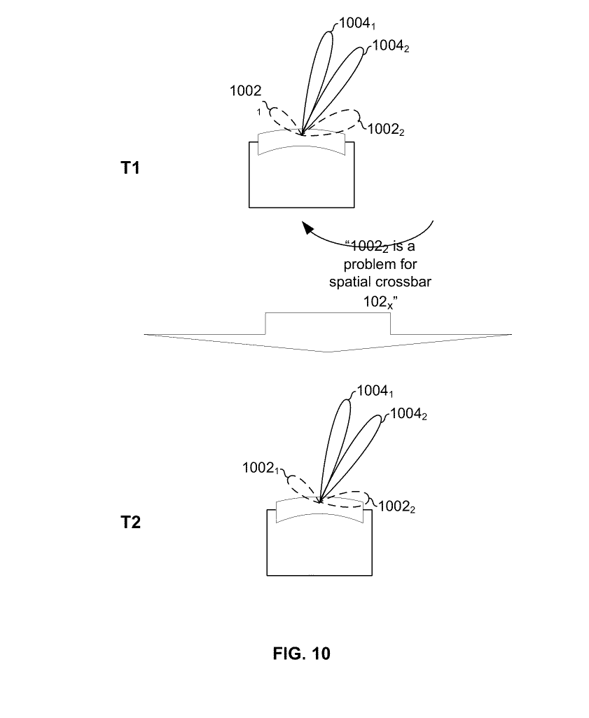

FIG. 10 illustrates configuration of a transmit antenna pattern of a spatial crossbar. At time T1 the spatial crossbar 104₁ is transmitting two beams main/desired lobes 1004₁ and 1004₂ but also undesired lobes 1002₁ and 1002₂. In response to feedback indicating side lobe 1002₂ is problematic (e.g., because it is incident on another spatial crossbar 104 at an angle that the other spatial crossbar cannot place a receive null), at time T2 the spatial crossbar 104₁ may adjust its transmit pattern to change the angle of side lobe 1002₂.

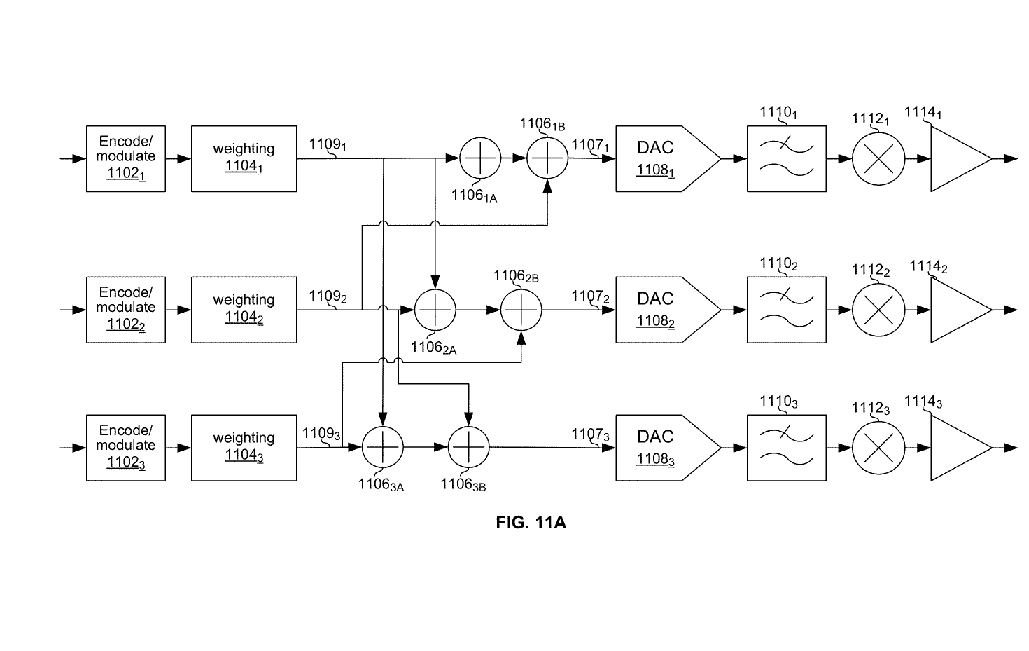

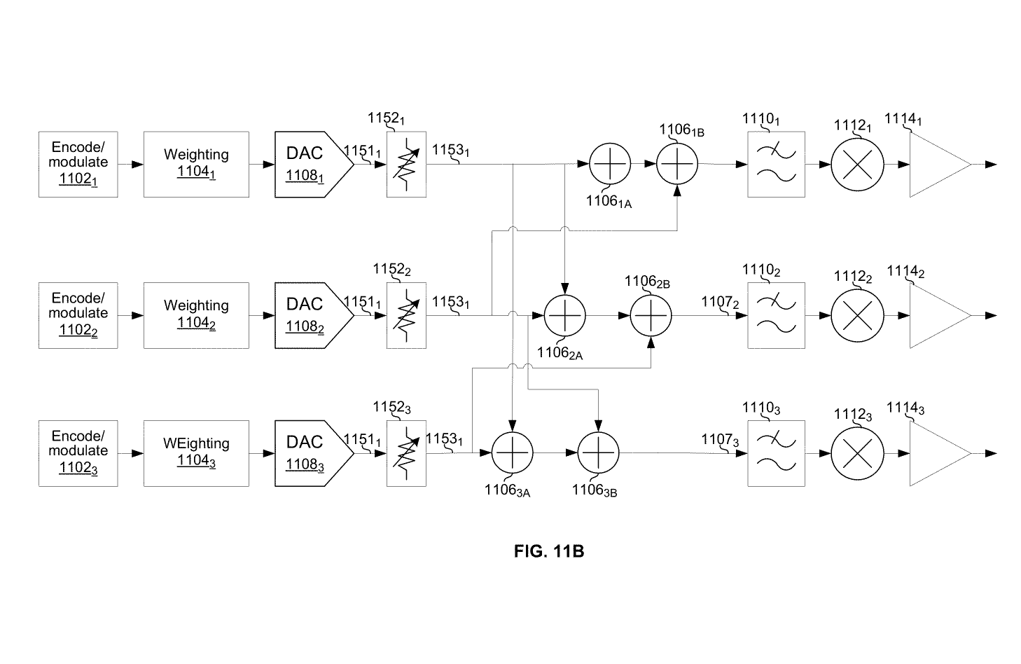

FIGS. 11A and 11B illustrate example circuitry of a spatial crossbar operable to independently control the transmit strength of each beam. Shown is an example implementation of circuitry 420 that supports three concurrent links (three chosen for simplicity of illustration). Each of three datastreams enters a respective one of encoding/modulation circuits 1102 which then outputs an encoded and modulated signal to a respective one of weighting circuits 1104 which apply phase and/or amplitude coefficients for achieving the desired antenna pattern. The outputs of the weighting blocks are summed via adders 1106 to create signals 1107. Signals 1107 are then converted to analog for transmission via a respective Tx front-end comprising a respective filter 1100, upconverter 1112, and power amplifier 1114. The collective transmissions via three antenna elements 428_{T1}, 428_{T2} and 428_{T3} resulting in three desired lobes corresponding to three beams, as well as undesired side lobes. The power of each beam may be controlled by controlling the coefficients applied by weighting blocks 1104. In the architecture in FIG. 11A, decreasing the power of one or more particular beams may waste dynamic range of the DACs 1108. Accordingly, in FIG. 11B, gain control is done via a variable attenuator 1152 in the analog domain such that the full range of each DAC 1108 is used regardless of subsequently applied attenuation.

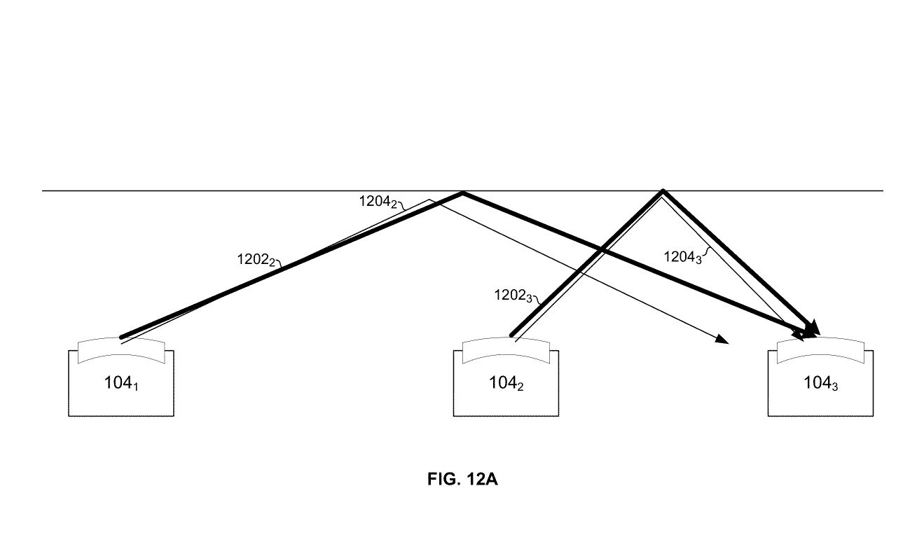

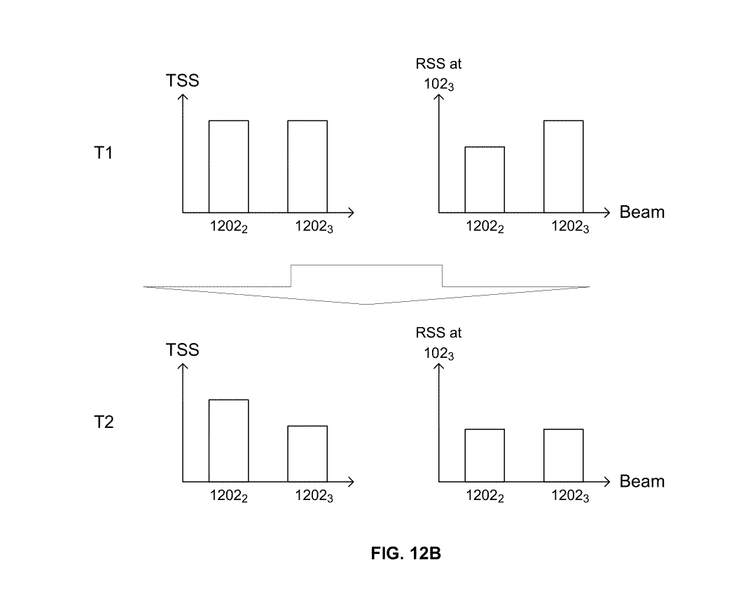

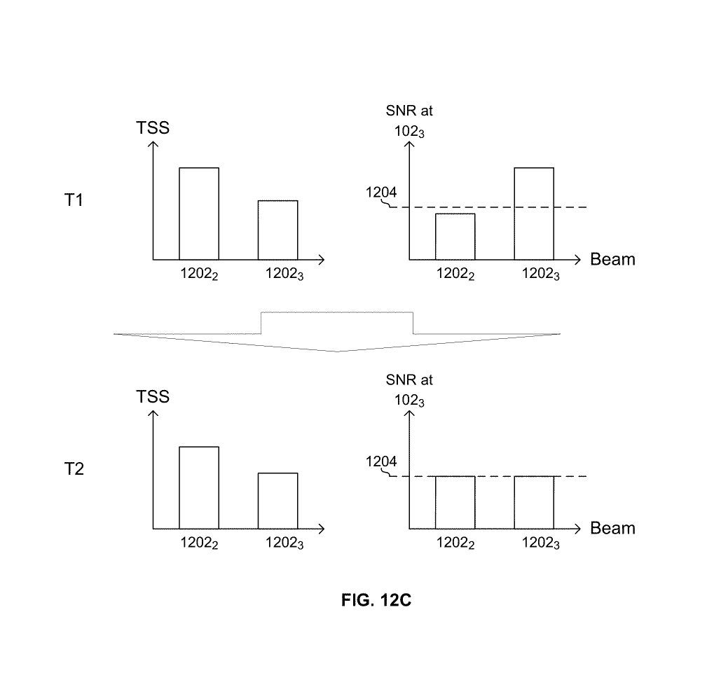

FIGS. 12A-12C depict beam power control in an example network of three spatial crossbars. Shown are desired beams 1202 and side lobes 1204.

Beam power may be controlled to, for example, account for varying path losses between different spatial crossbars. For example, beam 1202₂ travels further than beam 1202₃ and, consequently, if the beams are transmitted at the same strength by spatial crossbars 104₁ and 104₂, respectively, then the received signal strength (RSS) at spatial crossbar 104₃ is lower for beam 1202₂ than for beam 1202₃. This is the situation at time T1 in FIG. 12B. It may, however, be desirable to have equal, or approximately equal, RSS over all received beams. Accordingly, the spatial crossbar 104₃ may report the respective RSSs to the spatial crossbar 104₁ and 104₂ and they may adjust their transmit power accordingly, as has occurred at time T2 in FIG. 12B.

Beam power may be controlled to, for example, account for varying interference or noise impacting different beams. For example, beam 1202₂ may suffer more interference from side lobes than beam 1202₃ and, consequently, may have a lower SNR despite the transmit powers having been set for equal RSS, as, for example, described below with reference to FIG. 12C. Such is the situation at time T1 in FIG. 12C, where dashed line 1204 indicates a threshold SNR required for receiving any particular beam with less than a threshold number of errors. Accordingly, the spatial crossbar 104₃ may report the SNRs to spatial crossbars 104₁ and 104₂ and the spatial crossbars 104₁ and 104₂ may adjust the beam powers to allocate more ADC/DAC dynamic range to beam 1202₂ and less to beam 1202₃ such that each is received at (with some desired margin) the threshold SNR. Such is the situation at time T2 in FIG. 12C.

Similar beam power control may be performed by the spatial crossbar 104₃ for beams transmitted to 104₁ and 104₂, by the spatial crossbar 104₁ for a beam transmitted to spatial crossbar 104₁, and by the spatial crossbar 104₂ for a beam transmitted to the spatial crossbar 102₁.

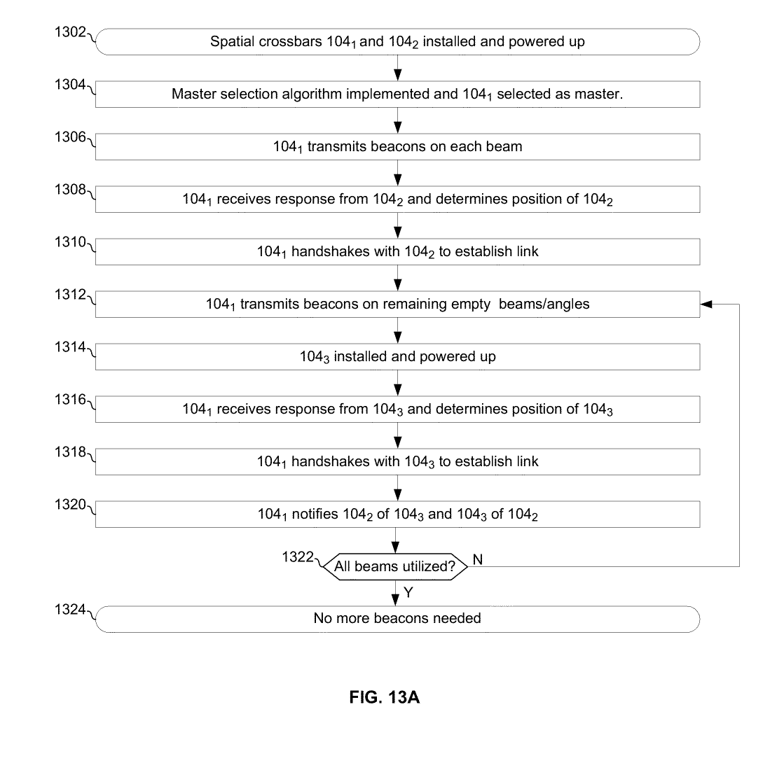

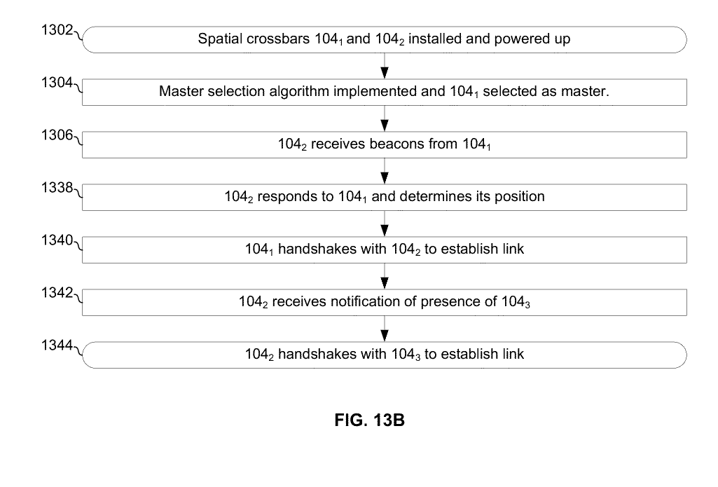

FIG. 13A is a flowchart illustrating an example auto-configuration process performed in a spatial crossbar functioning as a network master.

In block 1302, spatial crossbars 104₁ and 104₂ are installed in corresponding racks 102₁ and 102₂ in a data center. In block 1304, a master selection algorithm results in spatial crossbar 102₁ being chosen as master. Any suitable master selection algorithm may be used.

In block 1306, spatial crossbar 104₁ transmits beacons on each beam corresponding to each possible position of another spatial crossbar in the data center. For example, where up to 16 spatial crossbars in a group are supported, the spatial crossbar 104₁ may transmit a beacon on each of the 15 beams. In an example implementation, the beacons may comprise pilot patterns transmitted on particular OFDM sub-bands. The particular pattern and/or the particular sub-band may be unique to each beam and may serve to distinguish the beams.

In block 1308, spatial crossbar 104₁ receives a beacon response from spatial crossbar 104₂. Spatial crossbar 104₁ then determines the position of 104₂ based on characteristics of the response (e.g., the angle of at which it was received, the OFDM sub-band used, etc.).

In block 1310, the spatial crossbars 104₁ and 104₂ participate in a handshaking routine to establish a full-duplex millimeter wave link between them.

In block 1312, spatial crossbar 104₁ transmits beacons on the remaining beams which are not yet known to be occupied (e.g., if the spatial crossbar 104₁ supports 15 beams, it transmits beacons on the 14 beams/angles not corresponding to spatial crossbar 104₂).

In block 1314, spatial crossbar 104₃ of rack 102₃ is installed and powered up.

In block 1316, spatial crossbar 104₁ receives a beacon response from spatial crossbar 104₃. Spatial crossbar 104₁ then determines the position of 104₃ based on characteristics of the response (e.g., the angle of at which it was received, the OFDM sub-band used, etc.).

In block 1318, the spatial crossbars 104₁ and 104₃ participate in a handshaking routine to establish a full-duplex millimeter wave link between them.

In block 1320, the spatial crossbar 104₁ notifies spatial crossbar 104₂ of spatial crossbar 104₃ and vice versa, such that spatial crossbars 104₂ and 104₃ can then establish a link between them.

In block 1322, if spatial crossbar 104₁ has unoccupied beams/angles (e.g., if it supports 15 beams but less than 15 are in use), then the process returns to block 1312. Otherwise, the process proceeds to block 1324 in which no more beacons are necessary and the spatial crossbar 104₁ is fully connected to the maximum number of link partners that it supports.

FIG. 13B is a flowchart illustrating an example auto-configuration process performed in a spatial crossbar functioning as a network slave.

Blocks 1302, 1304, and 1306 are as described with reference to FIG. 13A.

In block 1338, spatial crossbar 104₂ receives the beacon and determine its location relative to spatial crossbar 104₁ based on characteristics of the beacon (e.g., the angle of at which it was received, the pilot pattern, the OFDM sub-band used, etc.). The spatial crossbar 104₂ then sends a beacon response to spatial crossbar 104₁.

In block 1340, the spatial crossbars 104₁ and 104₂ participate in a handshaking routine to establish a full-duplex millimeter wave link between them.

In block 1342, the spatial crossbar 104₂ receives (e.g., from spatial crossbar 104₁ via an out-of-band control channel) notification of the presence and location of spatial crossbar 104₃.

In block 1344, the spatial crossbars 104₂ and 104₃ participate in a handshaking routine to establish a full-duplex millimeter wave link between them.

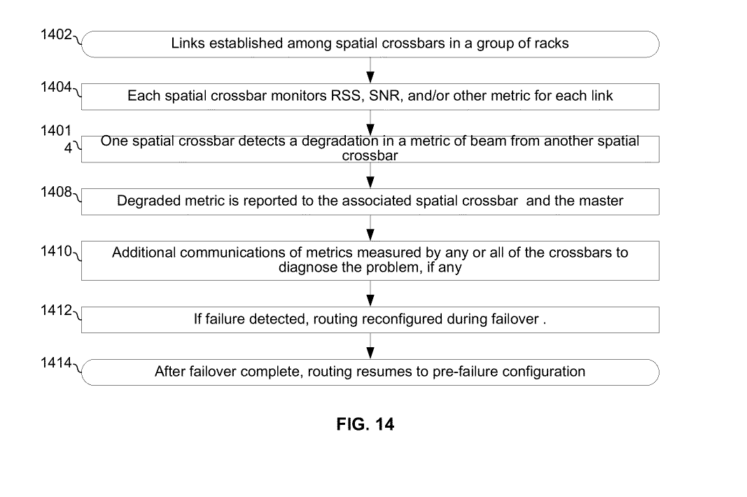

FIG. 14 is a flowchart illustrating an example process monitoring and failover in a network of spatial crossbars.

In block 1402, links are established among spatial crossbars in a group of racks.

In block 1404, each spatial crossbar monitors one or more metrics (e.g., received signals strength, signal-to-noise ratio, and/or the like) for each link.

In block 1406, one of the spatial crossbars detects a degradation in a metric of a link between the spatial crossbar and another spatial crossbar. Such a detection may be based on a relatively small fluctuation due to the largely static environment of the data center.

In block 1408, the degraded metric may be reported to the other spatial crossbar and/or to the master spatial crossbar.

In block 1410, additional data exchanges among the spatial crossbars may occur, including passing of additional metrics measured by other spatial crossbars, to diagnose whether a problem exists in the millimeter wave network.

In block 1412, if it is determined a failure has occurred, or is imminent, then routing among the spatial crossbars is temporarily reconfigured while failover takes place to replace the failed or failing spatial crossbar with a functioning spatial crossbar.

In block 1414, upon completion of the failover, the routing returns to the pre-failure configuration.

In accordance with an example implementation of this disclosure, a first server rack (e.g., 102₁) configured for housing one or more first servers (e.g., 104₁) and for connecting the one or more first servers to a network, may comprise a first millimeter wave transceiver circuit (e.g., 420), at least one phased array antenna (e.g., 428_{R1}-428_{RP} and 428_{T1}-428_{TP}), and a lens (e.g., 406). The lens and the millimeter wave transceiver circuit may be arranged on the server rack such that millimeter wave signals transmitted by the at least one phased array antenna are focused by the lens to form a first one or more millimeter wave beams at a corresponding one or more determined angles. The first millimeter wave transceiver circuit may be operable to transmit data from the one or more first servers to one or more second servers residing in a second server rack via the first one or more millimeter wave beams. The lens and the millimeter wave transceiver circuit may be arranged on the server rack such that one or more second millimeter wave beams incident on the lens from external to the first server rack at one or more determined angles are redirected by the lens onto the at least one phased array antenna. The first millimeter wave transceiver circuit may be operable to recover data from the one or more second millimeter wave beams and convey the recovered data to the first one or more servers. The first millimeter wave transceiver circuit may be operable to receive a plurality of datastreams from the one or more first servers via a fiber or copper link (e.g., 520). The fiber or copper link may connect the first millimeter wave transceiver circuit to a top-of-rack switch (e.g., 508) of the first server rack. The first millimeter wave transceiver circuit may be operable to transmit the plurality of datastreams via the one or more millimeter wave beams. Packets of the received plurality of datastreams may be presorted. On which of the first one or more millimeter wave beams each of the packets is transmitted may be based on an order in which the packets arrive at the first millimeter wave transceiver circuit via the fiber or copper link. On which of the first one or more millimeter wave beams that each one of the packets is to be transmitted may be based on which one of the plurality of fiber or copper links via which the one of the packets was received. The one or more millimeter wave beams may comprise a plurality of millimeter wave beams, and the first millimeter wave transceiver circuit may be operable to multiplex each of the plurality of datastreams onto each of the plurality of millimeter wave beams. The first millimeter wave transceiver circuit may be operable to adjust beamforming coefficients used for the first one or more millimeter wave beams based on a predetermined angle of reflection between the first server rack and the second server rack. The first millimeter wave transceiver circuit may be operable to adjust transmit power of each of the first one or more millimeter wave beams based on a predetermined angle of reflection between the first server rack and the second server rack. The lens may be mounted to a wall of the server rack and the first millimeter wave transceiver circuit may reside in the first server rack adjacent to the lens.

The present methods and systems may be realized in hardware, software, or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A system comprising:
a first server rack configured for housing one or more first servers and for connecting said one or more first servers to a network, said server rack comprising a first millimeter wave transceiver circuit, at least one phased array antenna, and a lens, wherein:
said lens and said millimeter wave transceiver circuit are arranged on said server rack such that:
millimeter wave signals transmitted by said at least one phased array antenna are focused by said lens to form a first one or more millimeter wave beams at a corresponding one or more determined angles; and
said first millimeter wave transceiver circuit is operable to transmit data from said one or more first servers to one or more second servers residing in a second server rack via said first one or more millimeter wave beams.

2. The system of claim 1, wherein said lens and said millimeter wave transceiver circuit are arranged on said server rack such that:
one or more second millimeter wave beams incident on said lens from external to said first server rack at one or more determined angles are redirected by said lens onto said at least one phased array antenna; and
said first millimeter wave transceiver circuit is operable to recover data from said one or more second millimeter wave beams and convey said recovered data to said first one or more servers.

3. The system of claim 1, wherein said first millimeter wave transceiver circuit is operable to receive a plurality of datastreams from said one or more first servers via a fiber or copper link.

4. The system of claim 3, wherein said fiber or copper link connect said first millimeter wave transceiver circuit to a top-of-rack switch of said first server rack.

5. The system of claim 3, wherein said first millimeter wave transceiver circuit is operable to transmit said plurality of datastreams via said one or more millimeter wave beams, wherein packets of said received plurality of datastreams are presorted and said first millimeter wave transceiver circuit is operable determine onto which of said first one or more millimeter wave beams that each of said packets is to be transmitted based on an order in which said packets arrive at said first millimeter wave transceiver circuit via said fiber or copper link.

6. The system of claim 3, wherein said first millimeter wave transceiver circuit is operable to transmit said plurality of datastreams via said one or more millimeter wave beams, wherein packets of said received plurality of datastreams are presorted and said first millimeter wave transceiver circuit is operable determine onto which of said first one or more millimeter wave beams that each one of said packets is to be transmitted based on which one of said plurality of fiber or copper links via which said one of said packets was received.

7. The system of claim 1, wherein:
said one or more millimeter wave beams comprise a plurality of millimeter wave beams; and
said first millimeter wave transceiver circuit is operable to multiplex each of said plurality of datastreams onto each of said plurality of millimeter wave beams.

8. The system of claim 1, wherein said first millimeter wave transceiver circuit is operable to adjust beamforming coefficients used for said first one or more millimeter wave beams based on a predetermined angle of reflection between said first server rack and said second server rack.

9. The system of claim 1, wherein said first millimeter wave transceiver circuit is operable to adjust transmit power of each of said first one or more millimeter wave beams based on a predetermined angle of reflection between said first server rack and said second server rack.

10. The system of claim 1, wherein said lens is mounted to a wall of said server rack and said first millimeter wave transceiver circuit resides in said first server rack adjacent to said lens.

11. A method comprising:
in a first server rack that is configured for housing one or more first servers and for connecting said one or more first servers to a network and that comprises a first millimeter wave transceiver circuit, at least one phased array antenna, and a lens:
transmitting millimeter wave signals via said at least one phased array antenna such that said millimeter wave signals are focused by said lens to form a first one or more millimeter wave beams at a corresponding one or more determined angles; and
transmitting data from said one or more first servers to one or more second servers residing in a second server rack via said first one or more millimeter wave beams.

12. The method of claim 11, wherein said lens and said millimeter wave transceiver circuit are arranged on said server rack such that one or more second millimeter wave beams incident on said lens from external to said first server rack at one or more determined angles are redirected by said lens onto said at least one phased array antenna, and the method comprises:
recovering data from said one or more second millimeter wave beams; and
conveying said recovered data to said first one or more servers.

13. The method of claim 11, comprising receiving a plurality of datastreams from said one or more first servers via a fiber or copper link.

14. The method of claim 13, wherein said fiber or copper link connect said first millimeter wave transceiver circuit to a top-of-rack switch of said first server rack.

15. The method of claim 13 wherein packets of said received plurality of datastreams are presorted and the method comprises:
determining which one or more of said first one or more millimeter wave beams that said plurality of datastreams are to be transmitted on based on an order in which said packets arrive at said first millimeter wave transceiver circuit via said fiber or copper link; and
transmitting said plurality of datastreams via said determined one or more of said first one or more millimeter wave beams.

16. The method of claim 13, wherein packets of said received plurality of datastreams are presorted and the method comprises:
determining onto which of said first one or more millimeter wave beams that each one of said packets is to be transmitted based on which one of said plurality of fiber or copper links via which said one of said packets was received; and
transmitting said plurality of datastreams via said one or more millimeter wave beams.

17. The method of claim 11, wherein said one or more millimeter wave beams comprise a plurality of millimeter wave beams, and the method comprises:
multiplexing each of said plurality of datastreams onto each of said plurality of millimeter wave beams.

18. The method of claim 11, comprising adjusting beamforming coefficients used for said first one or more millimeter wave beams based on a predetermined angle of reflection between said first server rack and a second server rack.

19. The method of claim 11, comprising adjusting transmit power of each of said first one or more millimeter wave beams based on a predetermined angle of reflection between said first server rack and a second server rack.

20. The method of claim 11, wherein said lens is mounted to a wall of said server rack and said first millimeter wave transceiver circuit resides in said first server rack adjacent to said lens.
